(19) United States
(12) Patent Application Publication
(10) Pub. No.: US 2009/0090440 A1
(43) Pub. Date: Apr. 9, 2009

(54) EXOTHERMIC ALLOYING BIMETALLIC PARTICLES

(75) Inventor: Richard M. Kellett, Longmeadow, MA (US)

Correspondence Address: O''Shea Getz P.C., 1500 MAIN ST. SUITE 912, SPRINGFIELD, MA, 01115, US

(73) Assignee: Ensign-Bickford Aerospace & Defense Company, Simsbury, CT (US)

(21) Appl. No.: 11/867,231

(22) Filed: Oct. 4, 2007

(51) Int. Cl. C06B 45/24; B05D 7/00; B22F 1/02

(52) U.S. Cl. 149/9; 427/216; 428/570; 149/3

(57) ABSTRACT

The compositions of different energetic metallic particles and corresponding coatings are chosen to take advantage of the resulting exothermic alloying reactions when the metals are combined or alloyed through heat activation. Bimetallic particles composed of a core/shell structure of differing metals are chosen such that, upon achieving the melt point for at least one of the metals, a relatively substantial amount of exothermic heat of alloying is liberated. In an embodiment, the core metal is aluminum and the shell metal is nickel. The nickel may be applied to the outer surface of the aluminum particles using an electroless process from a metal salt solution with a reducing agent in an aqueous solution or a solvent media. The aluminum particles may be pretreated with zinc to remove any aluminum oxide. The resulting bimetallic particles may be utilized as an enhanced blast additive by being dispersed within an explosive material.

### BACKGROUND OF THE INVENTION

The invention relates in general to exothermic alloying bimetallic particles, and more particularly to such particles that are formed using an electroless process and that may be used as an enhanced blast additive in the field of explosives due to the additional heat and pressure provided by the particles when mixed with various explosive materials.

Effects of explosive events can be amplified by incorporating particles within the explosive formulation that continue to react and/or liberate energy well after and far from the point of detonation. In some examples, hot metals are oxidized in air. In the case of aluminum, a thick, quenching oxide layer forms which limits the reaction completion. In other approaches, composite particles that bring together reactants that are thermally energized by detonation have been explored. While this offers the possibility of tailoring reactive properties, such as exothermicity, reaction rate, and other properties to maximize performance, the methods for such materials' preparation are typically achieved by employing relatively expensive and elaborate manufacturing methods, involving aerosols, high temperature, and vapor deposition. An example of this strategy has been the preparation of surface modified nanoparticles in which an oxidizer-rich layer is coated or grown around a metallic fuel particle such as aluminum.

What is needed is a flexible and inexpensive method of manufacturing heat activated, heat liberating particles with a relatively high reaction rate that may be utilized as an enhanced blast additive in the field of explosives.

### SUMMARY OF THE INVENTION

According to an aspect of the invention, the compositions of different energetic metallic core particles and corresponding metallic coatings are chosen to take advantage of the resulting exothermic alloying reactions when the metals are combined or alloyed through heat activation. The preparation and use of bimetallic particles composed of a core/shell structure of differing metals is chosen such that, upon achieving the melt point for at least one of the metals, a relatively substantial amount of heat of alloying is liberated. In a preferred embodiment, the core metal comprises aluminum and the shell metal comprises nickel. The nickel may be preferably applied to the outer surface of the aluminum particles using an electroless process from a metal salt solution with a reducing agent in an aqueous solution or a solvent media. To enhance the alloying process, a layer of zinc may be coated onto the outer surface of the aluminum particles after any aluminum oxide has been removed from the outer surface of these particles.

According to a further aspect of the present invention, the bimetallic particles formed according to the method of the present invention may be utilized as an enhanced blast additive in the field of explosives. As such, the bimetallic particles may be dispersed within a mixture containing an explosive material such as RDX or PETN. Then, when sufficiently heated by detonation of the explosive, exothermic alloying of the bimetallic particles is induced which propagates and liberates heat to affect temperature and pressure as the particles are propelled from the detonation. This way, the duration of and area affected by the explosive blast may be extended and better controlled by the bimetallic particles.

These and other objects, features and advantages of the present invention will become more apparent in light of the following detailed description of preferred embodiments thereof, as illustrated in the accompanying drawings.

### BRIEF DESCRIPTION OF THE DRAWINGS

The sole FIGURE is a cross-section of a cylindrical-shaped explosive device that incorporates the bimetallic particles of the present invention.

### DETAILED DESCRIPTION OF THE INVENTION

In accordance with the method of the present invention, the compositions of different energetic metallic core particles and corresponding metallic coatings are chosen to take advantage of the resulting exothermic reactions when the metals are combined during alloying following heat activation. Intermetallic or bimetallic particles comprised of a core/shell structure of differing metals have the metals selected such that, upon achieving the melt point for at least one of the metals and alloying has begun, a relatively substantial amount of the exothermic heat of alloying is liberated. In a preferred embodiment, the core metal comprises aluminum and the shell metal comprises nickel, although other metals for the core and shell may be utilized as is apparent to one or ordinary skill in the art in light of the teachings herein. As discussed in detail hereinafter, the nickel may be preferably applied to the outer surface of the aluminum particles using an electroless process from a metal salt solution with a reducing agent in preferably an aqueous solution or a solvent media.

In theory, any metal combination can be prepared as a core/shell (i.e., “bimetallic” or “intermetallic”) structure from metal particles, an appropriate dispersion medium, and deposition technique. For example, powders of nearly all metals have recently become commercially available (e.g., spherical aluminum powders from Valimet, Inc.) in a multitude of particle size ranges, including nanoparticles and nanotubules. Such relatively inexpensive alloying powders are commercially available in sizes ranging from approximately 20 nm to fractions of an inch, and with relatively high purity. However, forming the exterior shell around these particles often poses challenges and usually involves methods that inherently require relatively high vacuum, elevated temperatures, sophisticated chemistries, and associated high cost. In contrast, the deposition of the shell metal onto the core metal in accordance with the method of the present invention from homogenous media is potentially more convenient and cost effective.

Aluminum and nickel may form alloys with an exotherm in all mix proportions. The maximum heat of alloying is liberated when equal atom contents of the aluminum and nickel metals are present in the core/shell structure. Other metal combinations that may exhibit desirable exothermic alloys include aluminum and zirconium, aluminum and boron, boron and zirconium, boron and titanium, and silicon and vanadium. In these alternative combinations, the first metal listed comprises the core while the second metal listed comprises the outer shell. Other possible core metals include hafnium and magnesium, while other possible outer shell materials may include sulfur and selenium, which although technically not metals do exhibit desirable reactive and deposition properties similar to metals.

Newly developed electroplating techniques may be used to deposit or coat the nickel onto the aluminum particles. However, electroless processes are available as an alternative to electroplating and such electroless processes are preferred for use in the method of the present invention. Unlike electroplating, which requires electrical current and ohmic connections to drive the deposition of the nickel onto the aluminum particles, the electroless deposition process of the nickel onto the zinc-coated aluminum particles described hereinafter in a detailed example utilizes homogeneous chemical processes that are entirely suitable for deposition onto various particles such as spherical aluminum powder. Electroless nickel plating is a chemical reduction process that depends on the catalytic reduction process of nickel ions in an aqueous solution containing a chemical reducing agent and the subsequent deposition of nickel metal without the use of electrical energy.

Electroless nickel plating methods, while used for plating onto aluminum, are not well suited for plating, e.g., nickel, onto aluminum particles in the “raw” form of these particles. This is due to the presence of an oxide surface layer on the aluminum, where the oxide layer is non-electrically-conductive and resists adhesion of other materials such as nickel thereto. In accordance with the method of the present invention, as a preparation step prior to plating the nickel onto the aluminum particles, the aluminum is dispersed in an alkaline solution of zinc salt. This substitutes a thin layer of zinc oxide in place of the aluminum oxide. The zinc oxide is sufficiently electrically conductive and robust in acid media to enable the electroless deposition of the nickel onto the aluminum powder particles.

### EXAMPLE

The following is an exemplary embodiment of the method of the present invention for preparation of a bimetallic particle comprising an aluminum core and a nickel shell. The method can be divided into two stages: a first stage that involves the pretreatment of aluminum particles with zinc; and a second stage where the zinc pretreated aluminum particles are plated or coated with nickel. The first stage is utilized to remove any aluminum oxide that has formed on the outer surface of the aluminum, and the zinc applied to the outer surface of the aluminum prevents the reformation of aluminum oxide on the outer surface of the aluminum.

In the first stage, a first step is to mix 11 mL of zincate solution, which is a zinc/gluconate solution having an approximate pH of 13 with 100 mL of deionized water. The zincate solution is commercially available from Caswell Plating Company. Next, the solution is stirred relatively rapidly with a magnetic PTFE stirbar and the solution is brought to 65 degrees Centigrade. Then, 0.25 grams of aluminum powder commercially available from Valimet is added; specifically, the grade H-60 aluminum powder from Valimet. Next, the solution is stirred for 45 seconds, and then vacuum filtered through a 1.2 um PTFE membrane. Finally, the collected zinc coated aluminum particles are rinsed with deionized water.

In the second stage pretreated aluminum particles are nickel plated. For this step, 30 mL of Caswell Plating Company Nickel Plating Solution A (nickel sulfate) is mixed with 90 mL of Solution B (sodium hypophosphite), stirred with a PTFE coated stirbar and then heated to approximately 90-95 degrees Centigrade. Next, 0.29 grams of the zinc treated aluminum powder is added, and this temperature is maintained and the mixture is stirred until the appropriate amount of nickel is deposited or, for example, to achieve a 1:1 atom ratio of aluminum and nickel which corresponds to the maximum exothermic output. Then, the solution is vacuum filtered through a 1.2 um PTFE membrane. Finally, the collected aluminum core/nickel shell particles are rinsed with water, and then allowed to dry.

The aforementioned process co-deposits phosphorus in the nickel layer. In an alternative embodiment, deposition process, the nickel plating solution may contain additional materials such as, for example, boron.

While electroless plating of aluminum particles requires measures to remove the oxide layer, many materials such as boron, silicon, or zinc have semiconductive surfaces that enable plating directly. Carbon, because of its semiconductor behavior, may also be a core metal. Since the electroless process involves a reducing agent, some reducing agents, including the phosphorus or boron in the examples above, may co-deposit in the outer layer. In addition, small amounts of other metals or materials may be included in the plating formulation that may improve reaction rates or adhesion and may also co-deposit. Also, when used as the outer shell material, zirconium may be relatively more reactive than the other shell materials disclosed herein. Thus, to stabilize the zirconium somewhat, a layer of zinc may be used in between the core metal and the zirconium outer shell metal.

According to a further aspect of the present invention, the bimetallic particles formed according to the method of the present invention described above may be utilized as an enhanced blast additive in the field of explosives. As such, the bimetallic particles may be dispersed within an explosive material mixture. Then, when sufficiently heated, the bimetallic particles are heated to achieve an alloying threshold temperature which then propagates to alloy the entire particle, continuing to liberate heat even as the particles are directed away from the explosive source. The explosive material may comprise any type of explosive material that can mix with the bimetallic particles of the present invention as an enhanced blast additive, such as the well-known and commercially available octagen (HMX), hexahydrotrinitrotriazine (RDX), pentaerythritol tetranitrate (PETN), picrate salts and esters, dinitrobenzofuroxen and its salts, hexanitrohexaazoisowurtzitane (C-20), trinitrotoluene (TNT), glycidyl azide polymer (GAP), diazodinitorphenol (DDNP), lead styphnate and other styphnate salts, lead azide and other azide salts, triamino guanidine nitrate, tetranitro dibenzole trazapentalente, diamino hexanitro phenyl, triamino trinitrotoluene (TATB), or plastic bonded explosives (PBX).

Referring to the FIGURE, there illustrated in cross-section is a cylindrical explosive device (for example, a cylindrical warhead) 10 that comprises a relatively large number of the nickel coated aluminum bimetallic particles 12 prepared as described above by the method of the present invention. That is, in a preferred embodiment, each particle 12 comprises the inner core 14 of aluminum particles surrounded by the nickel shell 16. The bimetallic particles 12 are mixed in with or dispersed among an explosive material 18 in powder, or cast polymer form, such as, e.g., the aforementioned commercially available RDX or PETN. The entire device 10 is enclosed by a liner 20, which may comprise a suitable durable steel material. Typically, 10-40% by weight of the composition may be bimetallic particles although the optimal content is determined by the device requirements, the properties of the explosive, and the particles' energetic properties. Also, the explosive device 10 may be of other shapes, such as conical or tubular.

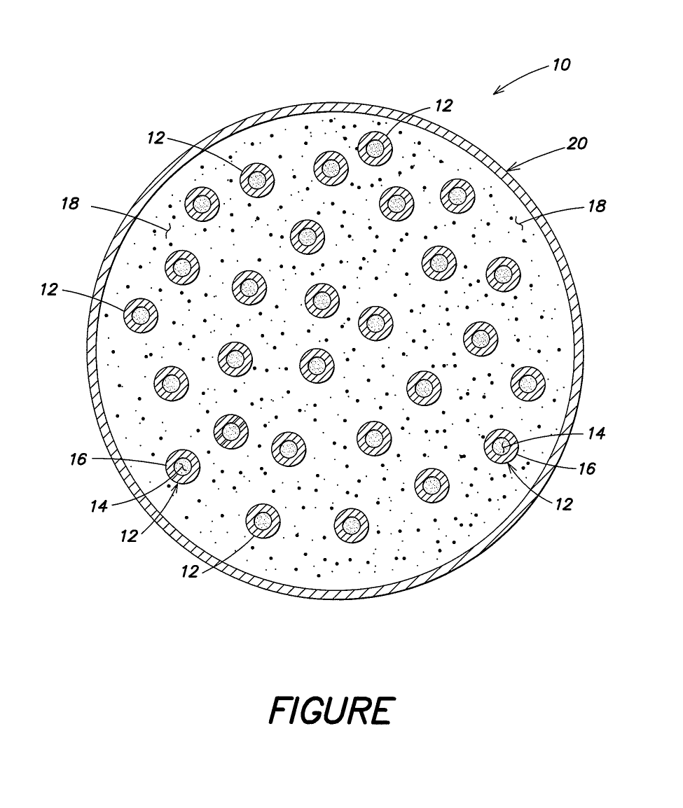

In an alternative embodiment of the explosive device 10 of FIG. 1, the particles 12 may not comprise a bimetallic particle that liberates heat in an exothermic alloying reacting. Instead, the particles 12 may each comprise a nanoparticle of a metal such as aluminum, boron, zirconium or magnesium, having a diameter of less than 100 nm. The nanoparticle acts as the core 14 of the particle and may have a coating 16 comprising one of various materials, such as Teflon (PTFE), or substantially fluorinated alkyl amines, phosphates, hydroxyls, phosphines, sulphonates, quaternary amines, thiols, or carboxylic acids. The particles 12 may be prepared by placing the core nanoparticle 14, such as aluminum in a beaker and heating the aluminum to a desired temperature. The coating material may then be added whereby it is deposited on the core nanoparticle by coating or establishing a chemical bond. The coated nanoparticles may then be dispersed within the explosive material 18. When the explosive material 18 is ignited it gives off relatively large amounts of heat and gas. A particle 12 comprised of an aluminum core 14 coated with a PTFE coating 16 is heated by the explosive material 18 and fluorine atoms from the PTFE move over to the aluminum, which causes heat to be liberated in a non-alloying reaction. The result of this alternative preferred embodiment is the same as that of the embodiment described above that utilizes an alloying reaction. That is, the coated nanoparticles 12 act as an enhanced blast additive.

The bimetallic particles may also be incorporated into otherwise inert structures, such as waveshapers in shape charge devices, to provide further blast enhancement. Another application of the bimetallic particles is as an alternative to fuel-oxidizer thermite mixtures in which compaction pressure sensitivity, or the requirement to bring together the reactive components, is difficult to accommodate.

Although the present invention has been illustrated and described with respect to several preferred embodiments thereof, various changes, omissions and additions to the form and detail thereof, may be made therein, without departing from the spirit and scope of the invention.

What is claimed is:

1. A method of making a plurality of particles each comprised of at least two different metals, the method comprising the steps of:
providing a core material of a first one of the metals, where the first metal comprises a plurality of powdered particles; and
coating an outer shell of a second one of the metals onto at least a portion of an outer surface of each of the plurality of particles of the core metal, where the step of coating comprises an electroless process from a metal salt solution with a reducing agent in an aqueous solution or a solvent media.

2. The method of claim 1, where the core metal is from the group that comprises aluminum, boron, silicon, hafnium, magnesium, or carbon.

3. The method of claim 1, where the outer shell metal is from the group that comprises nickel, zirconium, boron, titanium, sulfur, selenium, or vanadium.

4. The method of claim 1, where the core metal comprises an aluminum powder, and where the method further comprises the steps of removing any aluminum oxide from an outer surface of each of the aluminum powder particles and applying a coating of zinc to the outer surface of each of the aluminum powder particles, and where the step of coating comprises the step of coating the outer shell metal onto the coating of zinc.

5. A particle made by the method of claim 1.

6. A method of making a plurality of particles each comprised of at least two different materials, the method comprising the steps of:
providing a core material of a first one of the materials, where the first material comprises a plurality of powdered particles; and
coating an outer shell of a second one of the materials onto at least a portion of an outer surface of each of the plurality of particles of the first material, where the step of coating comprises the step of depositing the outer shell by forming a chemical bond.

7. The method of claim 6, where at least one of the plurality of particles has the core material comprise a nanoparticle of a metal, and where the outer shell material is from the group that comprises Teflon (PTFE), substantially fluorinated alkyl amines, phosphates, hydroxyls, phosphines, sulphonates, quaternary amines, thiols, or carboxylic acids.

8. The method of claim 6, where the step of forming the outer shell through chemical bonds comprises the steps of placing the core material in a container, heating the core material to a desired temperature, and adding the outer shell material into the container to mix with and react with the core material particles.

9. A particle made by the method of claim 6.

10. A device, comprising:
a plurality of particles, each particle including an inner core material and an outer shell material coating at least a portion of the inner core material of each particle; and
a third material having the plurality of particles dispersed therewithin, where when the third material is ignited heat is liberated by the third material and the liberated heat heats the plurality of particles to a temperature sufficient for the plurality of particles to each liberate heat.

11. The device of claim 10, where at least one of the plurality of particles comprises the inner core material of a first metal and the outer shell material of a second metal to form a bimetallic particle, and where the heat liberated from the third material heats the bimetallic particle a self propagating exothermic alloying reaction occurs within the bimetallic particle which liberates heat from the bimetallic particle.

12. The device of claim 11, where the inner core material is from the group that comprises aluminum, boron, silicon, hafnium, magnesium, or carbon.

13. The device of claim 11, where the outer shell material is from the group that comprises nickel, zirconium, boron, titanium, sulfur, selenium, or vanadium.

14. The device of claim 11, where at least one of the plurality of particles has the inner core material comprise a nanoparticle of a metal, and where the outer shell material is from the group that comprises Teflon (PTFE), substantially fluorinated alkyl amines, phosphates, hydroxyls, phosphines, sulphonates, quaternary amines, thiols, or carboxylic acids.

15. The device of claim 14, where heat liberated from the third material heats at least one of the plurality of particles resulting in a non-alloying reaction which liberates heat from the at least one particle.

16. The device of claim 11, where each of the plurality of particles comprises a powdered core material of aluminum, where the aluminum powdered core material comprises a plurality of particles having any aluminum oxide removed from an outer surface of each aluminum particle and having a zinc coating on the outer surface of each aluminum particle, and where each zinc coated aluminum particle includes a coating of nickel on an outer surface of the zinc-coated aluminum particles, where the nickel coating comprises the out shell material.

17. The device of claim 11, where the device comprises an explosive device.

18. The device of claim 11, where the device comprises an inert structure.

19. The device of claim 18, where the inert structure comprises a waveshaper.

20. The device of claim 11, where the third material is an explosive material from the group that comprises octagen (HMX), hexahydrotrinitrotriazine (RDX), pentaerythritol tetranitrate (PETN), picrate salts and esters, dinitrobenzofuroxen and its salts, hexanitrohexaazoisowurtzitane (C-20), trinitrotoluene (TNT), glycidyl azide polymer (GAP), diazodinitorphenol (DDNP), lead styphnate and other styphnate salts, lead azide and other azide salts, triamino guanidine nitrate, tetranitro dibenzole trazapentalente, diamino hexanitro phenyl, triamino trinitrotoluene (TATB), or plastic bonded explosives (PBX).
